(19) United States
(12) Patent Application Publication
(10) Pub. No.: US 2017/0023946 A1
(43) Pub. Date: Jan. 26, 2017

(54) FLIGHT CONTROL SYSTEM WITH DUAL REDUNDANT LIDAR

(71) Applicant: Goodrich Corporation, Charlotte, NC (US)

(72) Inventor: Ian P. Humphrey, Foxboro, MA (US)

(73) Assignee: Goodrich Corporation, Charlotte, NC (US)

(21) Appl. No.: 14/682,785

(22) Filed: Apr. 9, 2015

(51) Int. Cl. G05D 1/10; G01S 17/89; G01S 17/93; B64C 39/02; B64D 45/08

(52) U.S. Cl. CPC G05D 1/101; B64C 39/024; B64D 45/08; G01S 17/933; G01S 17/89

(57) ABSTRACT

A flight control system includes a first sensor assembly and a second sensor assembly with substantially redundant sensor capabilities as the first sensor assembly. A flight control system is operatively connected to the first and second sensor assemblies to control each assembly individually. Sensors of the first and second assemblies can include LIDAR and EO/IR sensors. The first and second sensor assemblies can be each mounted in a respective gimbal such that the first and second sensors rotate varying degrees to obtain a desired field of view.

### BACKGROUND OF THE INVENTION

1. Field of the Invention

The present disclosure relates to laser imaging systems, and more particularly to the use of laser imaging systems within a flight control system.

2. Description of Related Art

Unmanned aerial vehicles (UAVs) are remotely piloted or autonomous aircrafts that can carry cameras, sensors, communications equipment, or other payloads. UAVs have proven their usefulness in military applications in recent years. Large UAVs have executed surveillance and tactical missions in virtually every part of the world. Smaller UAVs have been used all over the world as a short-range video reconnaissance platform. In addition to military applications, there are many civilian applications, including government applications, such as firefighting and law enforcement. In the private sector, there also exists a range of surveillance applications for UAVs, for example, for use by the media and agriculture.

The potential for collisions is considerable in the context of UAVs. Typically, a remotely located operator manages and controls the UAV from a ground control station. Although the ground control station enables some degree of controlled flight, generally, UAVs need the ability scout out their surrounding airspace and watch for incoming obstacles and locate/identify potential landing surfaces.

Such conventional methods and systems have generally been considered satisfactory for their intended purpose. However, there is still a need in the art for improved flight systems for unmanned aerial vehicles. The present disclosure provides a solution for this need.

### SUMMARY OF THE INVENTION

A flight control system includes a first sensor assembly and a second sensor assembly with substantially redundant sensor capabilities as the first sensor assembly. A flight control system is operatively connected to the first and second sensor assemblies to control each assembly individually.

Sensors of the first and second assemblies can include LIDAR sensors. The first and second sensor assemblies can be each mounted in a respective gimbal such that the first and second sensors rotate varying degrees to obtain a desired field of view.

The flight control system can be configured to direct the first and second sensors to overlapping fields of view. Alternatively, the flight control system can be configured to direct the first and second sensors to non-overlapping fields of view. The flight control system can be configured to continuously operate the first and second sensors in an “on” mode with one of the first and second sensors selectively toggling between an “on/off” mode.

A processor having a memory can be operatively connected to the first and second sensor assemblies, wherein the memory includes instructions recorded thereon that, when read by the processor, cause the processor to detect objects in front of the aircraft during forward flight. The memory can further instructions recorded thereon that, when read by the processor, cause the processor to identify a suitable landing area. The first and second sensor assemblies can include polarization sensors wherein the memory, when ready by the processor, cause the processor to indicate material of an object or surface detected by the first and second sensors based on polarization detected with respective polarization sensors.

A method for providing dual redundancy for a flight system includes observing a first field of view of a first sensor assembly and observing a second field of view of a second sensor assembly. The first and second sensor assemblies are controlled individually.

The method can further include rotating each of the sensor assemblies such that the fields of view are overlapping. In certain circumstances, the sensor assemblies can be rotated such that the fields of view are separate and distinct. The method can further include detecting objects in front of the aircraft to avoid collisions and identify a suitable landing area.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic view of an exemplary embodiment of a flight system constructed in accordance with the present disclosure, showing dual LIDAR systems; and

FIG. 2 is a block diagram of the system of FIG. 1, showing the LIDAR systems coupled to a processor and memory.

### DETAILED DESCRIPTION OF THE PREFERRED EMBODIMENTS

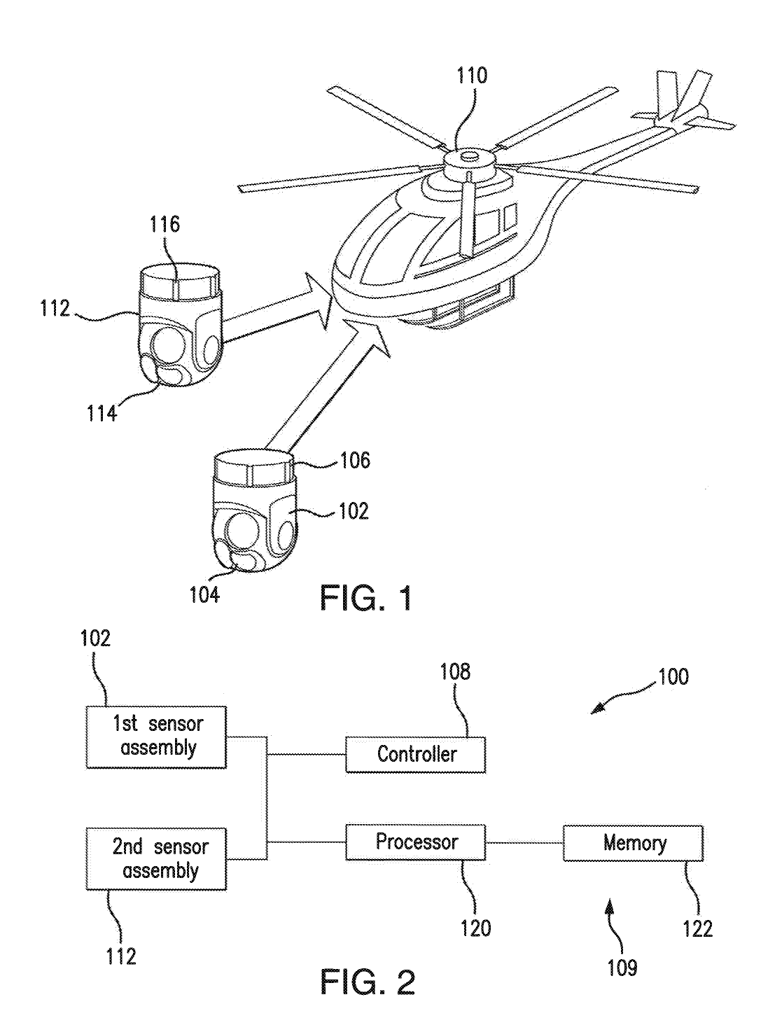

Reference will now be made to the drawings wherein like reference numerals identify similar structural features or aspects of the subject disclosure. For purposes of explanation and illustration, and not limitation, a partial view of an exemplary embodiment of a sensor system in accordance with the disclosure is shown in FIG. 1 and is designated generally by reference character 100. Other embodiments of the system and method in accordance with the disclosure, or aspects thereof, are provided in FIGS. 2-3, as will be described.

With reference to FIGS. 1 and 2, a schematic illustration of the sensor system 100 of the present disclosure is shown. The sensor system includes dual redundant sensor assemblies 102, 112 for altitude and range measurements, terrain mapping and obstacle avoidance. The sensor assemblies 102, 112 include a first sensor assembly 102 operatively coupled to a forward sector of an aircraft 110 and a second sensor assembly 112 operatively coupled to the aircraft a distance away from the first sensor assembly 102. The second sensor assembly 112 includes substantially redundant sensor capabilities as with the first sensor assembly 102. As shown in FIG. 1, the sensor assemblies 102, 112 are shown both at the forward sector, linearly spaced apart from one another, however other configurations are contemplated without distracting from the scope of the present disclosure. Each sensor assembly 102, 112 includes a sensor 104, 114 mounted within a gimbal 106, 116 to allow complete rotation of each sensor 104, 114. The sensors 104, 114 are preferably LIDAR sensors that can contain EO/IR capabilities measuring distance to an object or surface by illuminating the object/surface with a laser and analyzing the reflected light.

The first and second sensor assemblies 102, 112 provide dual redundancy and an increased field of view to the aircraft. Specifically, the sensor assemblies 102, 112 are operatively connected to a flight system 109 including a processor 120 and memory 112 located either on the aircraft 110 or remotely. The memory includes instructions which when read by the processor cause the processor to detect objects in front of the aircraft and identify a suitable landing area. Particularly useful in unmanned aerial vehicles (UAVs), (and alternatively unmanned surface vehicles, on land or on water) the first and second sensor assemblies 102, 112 are individually controlled by a controller 108 such that the fields of view of the sensors 104, 114 may or may not overlap. For example, prior to landing or docking, the first sensor assembly 102 can be positioned to look forward ahead of the aircraft 110 to view where the aircraft 110 is going. The second sensor assembly 112 can be positioned to view the ground or surface below the aircraft/vehicle 110 to identify a suitable landing area. When a landing area is identified and the aircraft 110 begins to descend and/or hover over the landing area the first sensor assembly 102 can rotate to view the landing surface. The dual redundancy of the two sensor assemblies 102, 112 also increases field of view within a degraded environment when both assemblies have overlapping fields of view. Moreover, each of the sensor assemblies 102, 112 can have polarization channels independent of each other to distinguish between natural material and manmade material when viewing an object or surface. The controller 108 can operate one or both of the sensor assemblies 102, 112 either continuously or intermittently, as needed. More specifically, for example, the first sensor assembly can continuously operate in an “on” mode while the second sensor assembly operates in an “on/off” mode and vice versa. Furthermore, the dual redundancy also provides for a backup if one of the sensor assemblies 102, 112 fails. For example, if the first sensor assembly 102 fails, the second sensor assembly 112 will continue running if the second sensor assembly 112 was in the “on” mode or may be switched to the “on” mode to provide substantially the same operations as the first sensor assembly 102.

A method of using the system of FIGS. 1 and 2 includes observing a first field of view of a first sensor assembly, e.g., first sensor assembly 102, and observing a second field of view of a second sensor assembly, e.g., second sensor assembly 112. The method can further include rotating each of the sensor assemblies such that the fields of view are overlapping. In certain circumstances, the sensor assemblies can be rotated such that the fields of view are separate and distinct. The method can further include detecting objects in front of the aircraft to avoid collisions and identifying a suitable landing area.

The methods and systems of the present disclosure, as described above and shown in the drawings, provide for a flight with superior properties including dual redundancy using LIDAR sensors. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A sensor system, comprising:
a first sensor assembly;
a second sensor assembly with substantially redundant sensor capabilities with the first sensor assembly; and
a flight control system operatively connected to control the first and second sensor assemblies individually.

2. The sensor system of claim 1, wherein sensors of each of the first and second sensor assemblies include respective LIDAR sensors that can contain EO/IR imaging sensors.

3. The sensor system of claim 2, wherein the first and second sensor assemblies are each mounted in a respective gimbal such that first and second sensors of each sensor assembly can rotate varying degrees to obtain a desired field of view.

4. The sensor system of claim 3, wherein the flight control system is configured to direct first and second sensors to overlapping fields of view.

5. The sensor system of claim 3, wherein the flight control system is configured to direct first and second sensors to non-overlapping fields of view.

6. The sensor system of claim 1, wherein the flight control system is configured to direct first and second sensor assemblies to continuously operate in an “on” mode with one of the first and second sensors selectively toggling between an “on/off” mode.

7. The sensor system of claim 1, further comprising a processor having a memory operatively connected to the first and second sensor assemblies, wherein the memory includes instructions recorded thereon that, when read by the processor, cause the processor to:
detect objects in front of the aircraft.

8. The sensor system of claim 7, wherein the memory includes instructions recorded thereon that, when read by the processor, cause the processor to:
identify a suitable landing area.

9. The sensor system of claim 7, wherein each of the first and second sensor assemblies can include polarization channels, wherein the memory includes instructions recorded thereon that, when ready by the processor, cause the processor to:
indicate material of an object or surface detected by the first and second sensors based on polarization detected with the respective polarization channels.

10. A method of providing dual redundancy for a flight control system:
observing a first field of view of a first sensor assembly operatively coupled to a forward sector of an aircraft;
observing a second field of view of a second sensor assembly operatively coupled to the aircraft positioned a distance from the first sensor assembly; and
controlling the first and second sensor assemblies individually with a flight control system.

11. The method of claim 10, further comprising rotating each of the first and second sensors about a gimbal axis mounted to the aircraft such that the first and second field of views overlap.

12. The method of claim 11, further comprising rotating each of the first and second sensors such that the first and second fields are separate and distinct.

13. The method of claim 10, wherein sensors of each of the first and second sensor assemblies include LIDAR sensors that can contain EO/IR imaging sensors.

14. The method of claim 10, further comprising detecting objects in front of the aircraft to avoid collisions.

15. The method of claim 10, further comprising identifying a suitable landing area.
